(19) United States
(12) Patent Application Publication
(10) Pub. No.: US 2014/0204918 A1
(43) Pub. Date: Jul. 24, 2014

(54) TCP RECOVERY METHOD AND APPARATUS

(71) Applicant: Samsung Electronics Co., Ltd., Suwon-si (KR)

(72) Inventors: In-Dae HA, Suwon-si (KR); Tai-Ho YOON, Yongin-si (KR)

(73) Assignee: Samsung Electronics Co., Ltd., Suwon-si (KR)

(21) Appl. No.: 14/161,180

(22) Filed: Jan. 22, 2014

(30) Foreign Application Priority Data
Jan. 21, 2013 (KR) 10-2013-0006556

(51) Int. Cl. H04W 76/02; H04W 72/04

(52) U.S. Cl. CPC H04W 76/028; H04W 72/0446
USPC 370/336; 370/329

(57) ABSTRACT

A method for Transmission Control Protocol (TCP) recovery in a transmitter for a wireless communication system is provided. The method includes detecting an event for releasing a Radio Resource Control (RRC) connection with a receiver, storing a TCP packet for the receiver when the RRC connection is released, reestablishing the RRC connection with the receiver, determining whether a session for the stored TCP packet exists, and transmitting the stored TCP packet to the receiver when determined that the session for the stored TCP packet exists.

### CROSS-REFERENCE TO RELATED APPLICATION(S)

This application claims the benefit under 35 U.S.C. §119(a) of a Korean patent application filed on Jan. 21, 2013 in the Korean Intellectual Property Office and assigned Serial number 10-2013-0006556, the entire disclosure of which is hereby incorporated by reference.

### TECHNICAL FIELD

The present disclosure relates to a Transmission Control Protocol (TCP) recovery method and apparatus in a wireless communication system.

### BACKGROUND

Recently, as various types of communication devices are increasingly used, the amount of data traffic increases not only in a wired network but also in a wireless network.

FIG. 1 illustrates a Transmission Control Protocol (TCP) performance graph due to packet loss in a wireless communication system according to the related art.

In a general cell-based communication system, a Radio Resource Control (RRC) connection between a terminal and a base station may be released in an area where wireless environment is poor, such as a cell boundary. When there is traffic to be transmitted and received between the terminal and the base station, the terminal and the base station perform the RRC connection again within several seconds to several minutes. When the RRC connection is released in a Long Term Evolution (LTE) system, all TCP packets existing in a radio bearer are discarded (or lost). Therefore, lost TCP packets are re-transmitted and re-received when reestablishment of the RRC connection is performed. For example, when the RRC connection between the terminal and the base station is released in a state where the terminal establishes a TCP session with a specific server through the base station and receives TCP packets from the server, the base station loses all TCP packets which had been received from the server, but had not been transmitted to the terminal. Thereafter, when the terminal and the base station reestablish the RRC connection, the base station receives the lost packets from the server. When many packets are lost, the TCP window size of the server is reduced. Since several seconds to several minutes are taken to again increase the reduced TCP window size, a long time is required to recover TCP efficiency to a state before the RRC connection. In this case, the TCP window size refers to maximum data amount which is able to be transmitted at one time without a response from a receiver and varies dynamically according to network states. For example, when the RRC connection is released at a time point A 101 as illustrated in FIG. 1, TCP packets of 1.5 Mbytes existing in a radio bearer are lost, and when the RRC connection is reestablished, it will take about 200 seconds until a time point B 103 at which point the TCP window size increases again.

Therefore, there is a need for a method for rapidly recovering TCP efficiency in a wireless communication system where packet loss easily occurs.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for improving Transmission Control Protocol (TCP) efficiency when a Radio Resource Control (RRC) connection is released and then reestablished in a wireless communication system.

Another aspect of the present disclosure is to provide a method and apparatus for temporarily storing TCP packets existing in a radio bearer without discarding the TCP packets when a RRC connection is released in a wireless communication system and transmitting and receiving the temporarily stored TCP packets when the RRC connection is reestablished.

Another aspect of the present disclosure is to provide a method and apparatus for determining whether to temporarily store TCP packets existing in a radio bearer according to the size of the TCP packets when a RRC connection is released in a wireless communication system.

Another aspect of the present disclosure is to provide a method and apparatus for temporarily storing TCP packets existing in a radio bearer when a RRC connection is released in a wireless communication system and transmitting TCP packets through a TCP session corresponding to 5-tuple information of the temporarily stored TCP packets when the RRC connection is reestablished.

In accordance with an aspect of the present disclosure, a method for TCP recovery in a transmitter for a wireless communication system is provided. The method includes detecting an event for releasing a RRC connection with a receiver, storing a TCP packet for the receiver when the RRC connection is released, reestablishing the RRC connection with the receiver, determining whether a session for the stored TCP packet exists and transmitting the stored TCP packet to the receiver when determined that the session for the stored TCP packet exists.

In accordance with another aspect of the present disclosure, an apparatus for a transmitter for TCP recovery in a wireless communication system is provided. The apparatus includes a communication unit configured to transmit and receive signals to and from a receiver, and a control unit configured to detect an event for releasing a RRC connection with a receiver, to store a TCP packet for the receiver, to determine whether a session for the stored TCP packet exists when the RRC connection with the receiver is reestablished, and to transmit the stored TCP packet to the receiver when determined that the session for the stored TCP packet exists.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a Transmission Control Protocol (TCP) performance graph due to packet loss in a wireless communication system according to the related art;

FIG. 2 illustrates a hierarchical structure in a wireless communication system according to an embodiment of the present disclosure;

FIG. 3 illustrates a TCP packet storage configuration in a transmitter for a wireless communication system according to an embodiment of the present disclosure;

FIGS. 4A and 4B illustrate a TCP packet management process for a transmitter in a wireless communication system according to an embodiment of the present disclosure; and

FIG. 5 illustrates a block configuration of a transmitter in a wireless communication system according to an embodiment of the present disclosure.

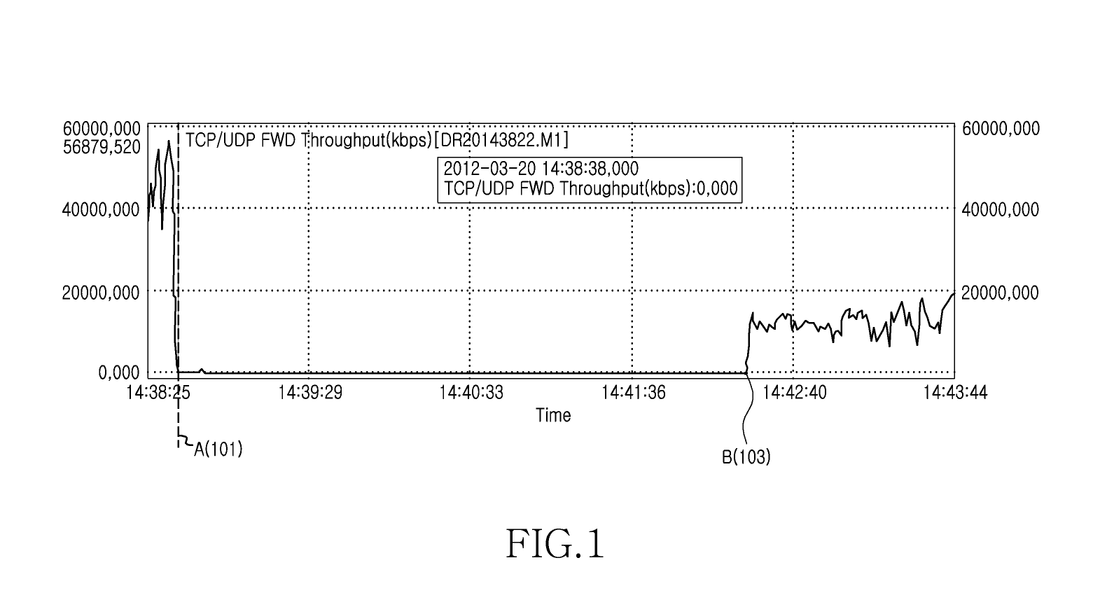

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure provides a method and apparatus for improving Transmission Control Protocol (TCP) efficiency in a case where a Radio Resource Control (RRC) connection is released and reestablished in a wireless communication system.

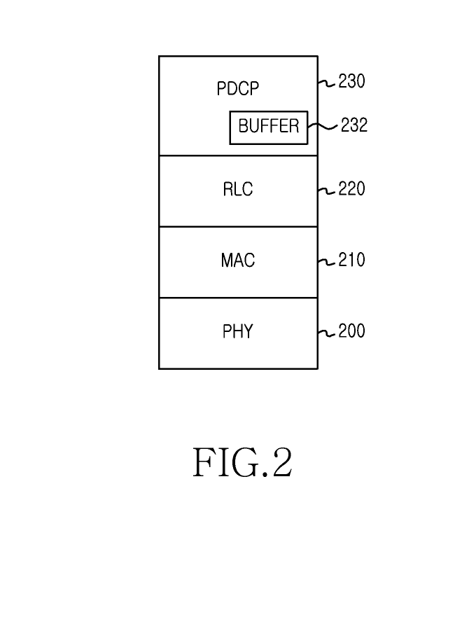

FIG. 2 illustrates a hierarchical structure of a transmitter in a wireless communication system according to an embodiment of the present disclosure.

Referring to FIG. 2, the hierarchical structure of the transmitter in the wireless communication system according to the embodiment of the present disclosure includes a Physical (PHY) layer 200, a Medium Access Control (MAC) layer 210, a Radio Link Control (RLC) layer 220, and a Packet Data Convergence Protocol (PDCP) layer 230.

The PHY layer 200 provides a function of transmitting data through a wireless channel. The MAC layer 210 is a layer for performing mapping between a logical channel and a transmission channel and selects a transmission channel for transmission of data received from the RLC layer 220 and adds required control information to the header of a MAC PDU. The RLC layer 220 performs a function of supporting reliable data transmission. The RLC layer 220 performs segmentation and concatenation for RLC SDUs (service data units) transferred from a higher layer in order to configure data having a size corresponding to a radio session. In addition, the RLC layer supports a data reassembly function in order to reconstruct original RLC SDUs from received RLC PDUs. The RLC layer 220 may operate in any one of a transparent mode TM, an Unacknowledged Mode (UM), and an Acknowledged Mode (AM) according to methods of processing and transmitting RLC SDUs. When operating in the TM, the RLC layer 220 transfers an RLC SDU received from a higher layer to the MAC layer 210 without adding any header information to the received RLC SDU. When operating in the UM, the RLC layer 220 does not support data retransmission and forms an RLC PDU by performing segmentation and concatenation for RLC SDUs. In this case, the RLC layer 220 adds header information including a serial number to the RLC PDU. When operating in the AM, the RLC layer 220 supports a data retransmission function and forms a RLC PDU by performing segmentation and reassembly of an RLC SDU. In this case, various parameters, such as a transmission window, a reception window, a timer, and a counter, and variables may be used for the retransmission function in the AM.

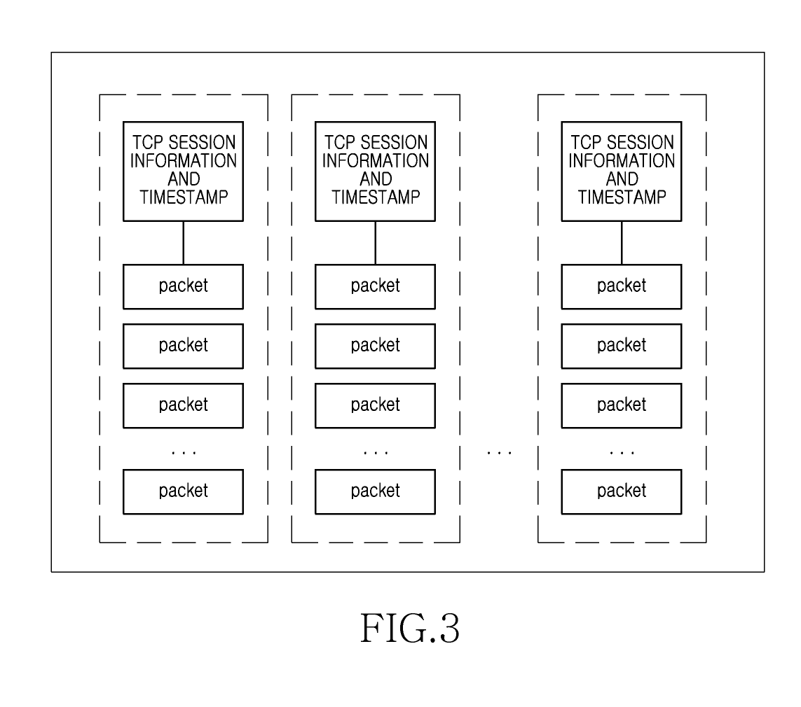

The PDCP layer 230 is used in a packet switching domain, and may compress and transmit the header of an IP packet to improve transmission efficiency of packet data in a radio channel. In particular, according to the embodiment of the present disclosure, the PDCP layer 230 performs a function of temporarily storing TCP packets existing in a radio bearer in the buffer 232 without discarding the TCP packets when a RRC connection with a receiver node is released and transmitting and receiving the temporarily stored TCP packets when the RRC connection with the receiver node is reestablished. In this case, the data existing in the radio bearer refers to data which is in a state of not being provided from the PDCP layer 230 to another layer. The PDCP layer 230 may temporarily store TCP packets in the buffer 232 according to the size or number of the TCP packets existing in the radio bearer or may discard the TCP packets without temporarily storing the TCP packets in the buffer 232. The PDCP layer 230 measures TCP session information and a RRC connection release time for the TCP packets existing in the radio bearer and maps TCP packets corresponding to respective TCP sessions onto the TCP session information and timestamp values representing RRC connection release times to store the same as illustrated in FIG. 3. In this case, the TCP session information may be referred to as 5-tuple information and may include information about a source IP address, a source port, a destination IP address, a destination port, and a protocol. For example, the PDCP layer 230 may identify the TCP session information and timestamp values of TCP packets existing in a radio bearer, and map the identified TCP session information and the identified timestamp value onto the respective TCP packets to store the same. When the reestablishment of the RRC connection is detected, the PDCP layer 230 detects a TCP session corresponding to the TCP session information of the TCP packet temporarily stored in the buffer 232 and controls and processes a function of transmitting the TCP packet through the detected TCP session. In addition, the PDCP layer 230 controls and processes a function of discarding TCP packets when there are TCP packets stored in the buffer for a threshold time or more. In this case, the PDCP layer 230 may determine whether the TCP packets are stored for the threshold time or more using timestamp values mapped onto respective TCP packets and stored. Discarding the TCP packets stored for the threshold time or more is to prevent TCP packets from being accumulated in the buffer 232 continuously. In this case, the buffer 232 may classify and store TCP packets based on TCP sessions. In this case, the buffer 232 may be a pool buffer.

FIG. 3 is a diagram illustrating a TCP packet storage configuration in a transmitter for a wireless communication system according to an embodiment of the present disclosure.

Referring to FIG. 3, and as discussed above, the PDCP layer 230 measures TCP session information and a RRC connection release time for the TCP packets existing in the radio bearer and maps TCP packets corresponding to respective TCP sessions onto the TCP session information and timestamp values representing RRC connection release times and stores the same.

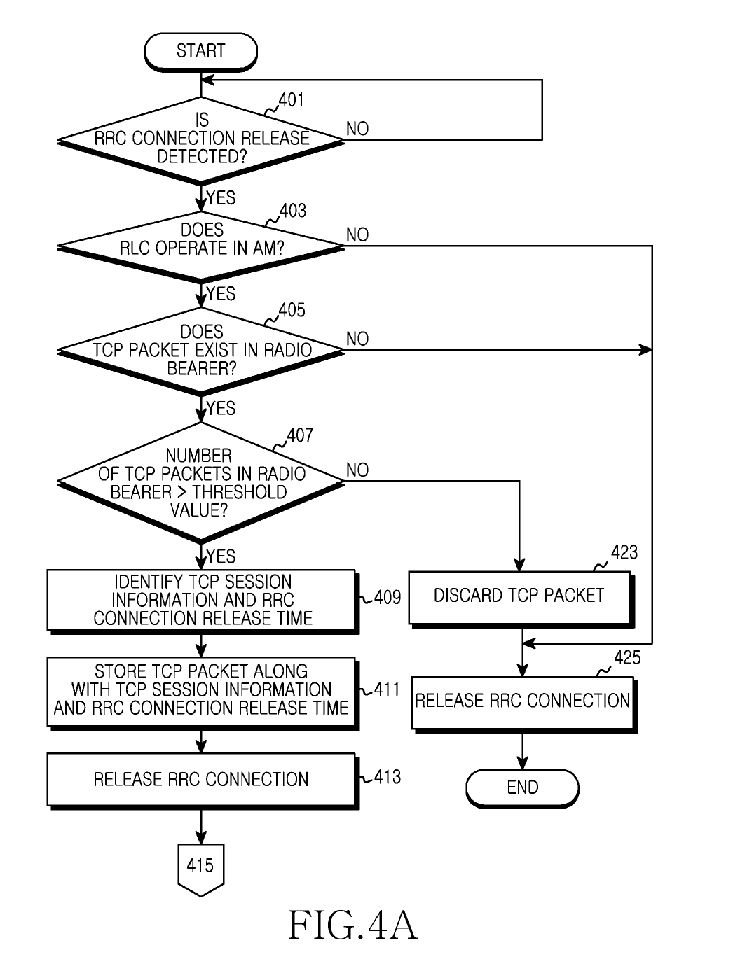

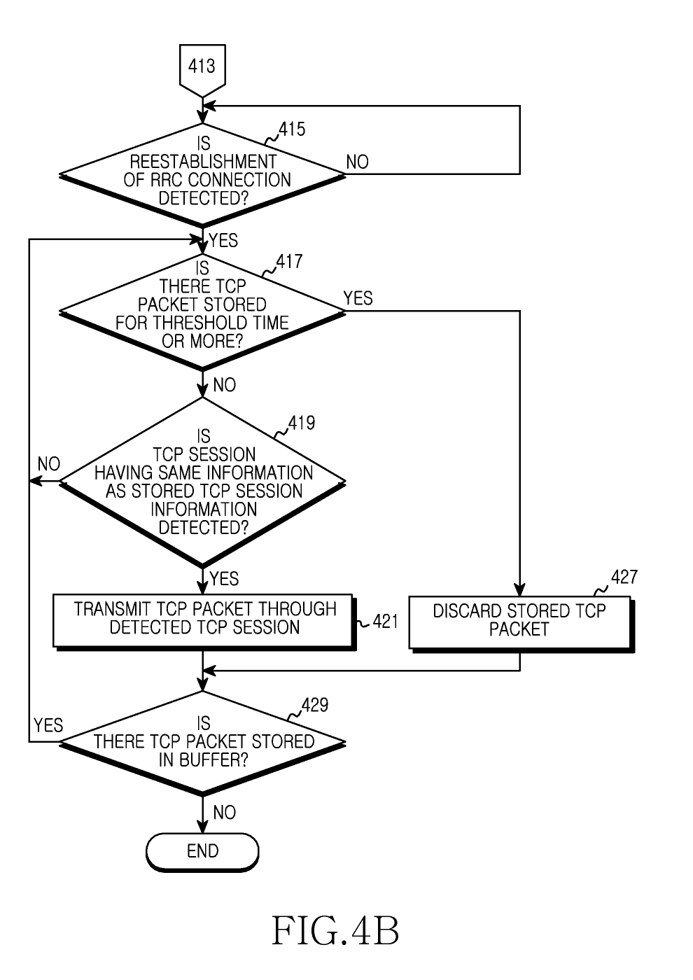

FIGS. 4A and 4B illustrate a TCP packet management process for a transmitter for a wireless communication system according to an embodiment of the present disclosure. For convenience of explanation, the following description is given under assumption that the transmitter is a base station, a receiver is a terminal, and the terminal receives data from a server through the base station. However, the present disclosure may be applied to a case where the transmitter is a terminal, the receiver is the base station, and the terminal transmits data to the server through the base station in the same manner. That is, the transmitter as described below may be the base station or the terminal.

Referring to FIGS. 4A and 4B, in operation 401, the transmitter detects whether an RRC connection with the receiver is released. When the RRC connection is not released, the transmitter performs operation 401 repeatedly to detect whether the RRC connection is released.

When the RRC connection is released, the transmitter determines or examines whether an RLC operates in an AM in operation 403. For example, when the RRC connection with the receiver is released, the transmitter examines whether the RLC layer 220, which processes transmitted and received data to and from the receiver, operates in a mode of supporting a retransmission function. When the RLC layer 220 does not operate in the AM, the transmitter releases the RRC connection in operation 425. When a TCP packet for a relevant receiver exists in a radio bearer, the TCP packet is automatically discarded.

On the other hand, when the RLC layer 220 operates in the AM, the transmitter examines whether the TCP packet exists in the radio bearer in operation 405. In this case, the transmitter examines whether the TCP packet associated with a receiver with which the RRC connection is released is not provided from the PDCP layer 230 to another layer. When the TCP packet does not exist in the radio bearer, the transmitter releases the RRC connection in operation 425.

On the other hand, when the TCP packet exists in the radio bearer, the transmitter examines whether the number of TCP packets existing in the radio bearer is larger than a threshold value in operation 407. When the number of TCP packets existing in the radio bearer is less than or equal to the threshold value, the transmitter proceeds to operation 423. According to design methods, the transmitter may compare the total size of TCP packets existing in the radio bearer with the threshold value, instead of the number of TCP packets existing in the radio bearer.

In operation 423, the transmitter discards the TCP packets existing in the radio bearer. In operation 425, the transmitter releases the RRC connection and ends the process according to the embodiment of the present disclosure.

When the number of TCP packets existing in the radio bearer is larger than the threshold value, the transmitter identifies the TCP session information of the TCP packets existing in the radio bearer and a RRC connection release time in operation 409. In this case, the TCP session information may be referred to as 5-tuple information and may include information about a source IP address, a source port, a destination IP address, a destination port, and a protocol. In addition, the RRC connection release time may indicate a time point at which the RRC connection release of operation 401 is detected.

In operation 411, the transmitter performs mapping of the identified TCP session information and the identified RRC connection release time onto a relevant TCP packet. For example, the transmitter performs mapping of the TCP packets existing in the radio bearer onto the TCP session information and the RRC connection release times to store them. In this case, the transmitter classifies the TCP packets existing in the radio bearer according to TCP sessions and stores the TCP packets.

Thereafter, the transmitter releases the RRC connection in operation 413 and detects whether the reestablishment of a RRC connection with a relevant receiver is performed in operation 415. That is, the transmitter detects whether the RRC connection is again performed on the receiver with which the RRC connection has been released in operation 413.

When the reestablishment of the RRC connection with the relevant receiver is detected, the transmitter examines whether there is a TCP packet stored in the buffer for a threshold time or more in operation 417. In this case, the transmitter determines whether a packet is stored for the threshold time or more based on the RRC connection release time mapped onto the TCP packet and stored. For example, the transmitter calculates a difference of time between RRC connection release times for respective TCP sessions and a current time. When the calculated difference time is equal to or larger than the threshold time, the TCP packet is determined as being stored for the threshold time or more. When there is the TCP packet stored in the buffer for the threshold time or more, the transmitter discards the TCP packet by deleting the TCP packet in the buffer in operation 427 and proceeds to operation 429.

When there is no TCP packet stored in the buffer for the threshold time or more, the transmitter examines whether a TCP session having the same information as the stored TCP session information in operation 419. For example, the transmitter examines whether a TCP packet having the same session information as the session information of the TCP packet stored in the buffer is received from the receiver or another node (for example, server). When a TCP packet having the same session information as the session information of the TCP packet stored in the buffer is received from the receiver or another node, the transmitter may determine that the TCP session between the receiver and the another node is established without being released. Since the server to which the terminal is connected through the TCP session does not detect the RRC connection release state even when the RRC connection between a base station and a terminal is released, the TCP session between the terminal and the server may be maintained even after the RRC connection is released and the server may continuously transmit TCP packets to the terminal or request a response (ACK) signal for the transmitted TCP packet from the terminal Therefore, the base station reestablishes the RRC connection and thereafter, receives a TCP packet or a response request signal from the server, thereby detecting the TCP session between the terminal and the server.

When the TCP session having the same information as the stored TCP session information is not detected, the transmitter returns to operation 417 and performs subsequent operations once again. On the other hand, when the TCP session having the same information as the stored TCP session information is detected, the transmitter transmits TCP packets mapped onto the detected TCP session information among the TCP packets stored in the buffer through the detected TCP session in operation 421. In this case, the transmitted TCP packets are deleted from the buffer.

Thereafter, the transmitter examines whether there is a TCP packet stored in the buffer in operation 429. When there is the TCP packet stored in the buffer, the transmitter returns to operation 417 to perform subsequent operations. When there is no TCP packet stored in the buffer, the transmitter ends the process according to the embodiment of the present disclosure.

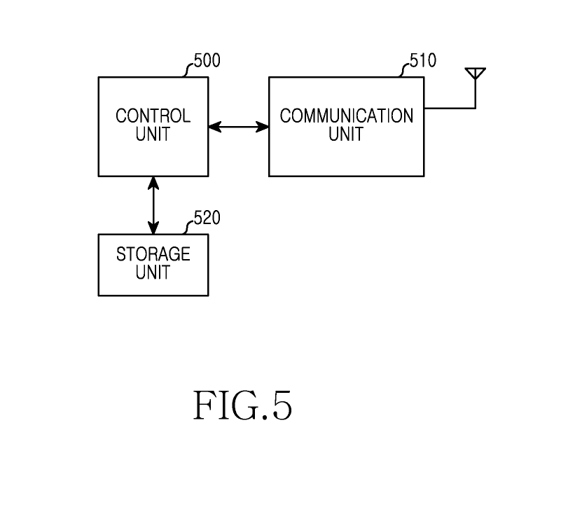

FIG. 5 illustrates a block configuration of a transmitter in a wireless communication system according to an embodiment of the present disclosure.

Referring to FIG. 5, the transmitter includes a control unit 500, a communication unit 510, and a storage unit (buffer) 520.

The control unit 500 controls and processes overall operation for communication of the transmitter. According to an embodiment of the present disclosure, when a RRC connection with a receiver is released, the control unit 500 temporarily stores a TCP packet existing in a radio bearer in the storage unit 520 without discarding the TCP packet. When the RRC connection with the receiver is established, the control unit 500 transmits the TCP packet temporarily stored in the storage unit 520 through the TCP session. In this case, the data existing in the radio bearer refers to data which is in a state of not being provided from the PDCP layer 230 to another layer.

Specifically, the control unit 500 examines whether the RLC layer 220 that processes data for the receiver with which the RRC connection is released operates in an AM which supports retransmission when an event for releasing a RRC connection is detected. When the RLC layer 220 operates in the AM, the control unit 500 examines whether there is a TCP packet for the receiver in the radio bearer and when the RLC layer 220 does not operate in the AM, the control unit 500 performs a process of releasing the RRC connection with the receiver. When there is a TCP packet for the receiver in the radio bearer, the control unit 500 compares the number of TCP packets of the receiver existing in the radio bearer with a threshold value and determines whether the TCP packets are discarded. When the number of the TCP packets for the receiver existing in the radio bearer is less than or equal to a threshold value, the control unit 500 discards the TCP packets. When the number of the TCP packets for the receiver existing in the radio bearer is larger than the threshold value, the control unit 500 stores the TCP packets in the storage unit 520. In this case, the control unit 500 identifies the TCP session information and information about a detection time of RRC connection release of the TCP packets existing in the radio bearer and maps the identified information onto the TCP packets to store the same. In this case, the TCP session information may include a source IP address, a source port, a destination IP address, a destination port, and protocol information.

The control unit 500 detects a TCP session having the same information as the TCP session information stored in the storage unit 520 when the RRC connection is reestablished after the release of the RRC connection with the receiver. When receiving the TCP packet having the same information as the TCP session information stored in the storage unit 520, the control unit 500 detects the existence of the TCP packet and controls and processes a function of transmitting relevant TCP packets stored in the storage unit 520.

In addition, the control unit 500 determines whether there is a TCP packet stored in the storage unit 520 for the threshold time or more based on a current time and the RRC connection release time of the TCP packet stored in the storage unit 520. In this case, when there is a TCP packet stored in the storage unit 520 for the threshold time or more, the control unit 500 deletes and discards the TCP packet in the storage unit 520.

The communication unit 510 performs transmission and reception of signals between a transmitter and a receiver, and with other nodes. The communication unit 510 transmits and receives the TCP packets according to control of the control unit 500.

The storage unit 520 stores various data and programs required for operation of the transmitter and stores TCP packets for respective TCP sessions according to various embodiments of the present disclosure. In this case, the storage unit 520 may store TCP session information, a RRC connection release time and many relevant TCP packets for respective TCP sessions. In this case, the storage unit 520 may include a pool buffer.

According to an embodiment of the present disclosure, the transmitter temporarily stores the TCP packets existing in the radio bearer without discarding the TCP packets when the RRC connection is released in a wireless communication system and transmits the TCP packets through a TCP session corresponding to the 5-tuple information of the temporarily stored TCP packets when the RRC connection is reestablished, thereby preventing packet loss, rapidly recovering TCP performance, and preventing traffic transmission and reception efficiency from being degraded.

The operations according to various embodiments of the present disclosure may be implemented by a single control unit. In this case, program commands for performing operations implemented by various computers may be recorded in a computer-readable medium. The computer-readable recording medium may include program commands, data files, and data structures either alone or in combination. The program commands may be those that are especially designed and configured for the present disclosure, or may be those that are publicly known and available to those skilled in the art. Examples of the computer-readable recording medium include magnetic recording media such as hard disks, floppy disks and magnetic tapes, optical recording media such as Compact Disc-Read Only Memories (CD-ROMs) and Digital Versatile Discs (DVDs), magneto-optical recording media such as floptical disks, and hardware devices such as ROMs, Random Access Memories (RAMs) and flash memories that are especially configured to store and execute program commands. Examples of the program commands include machine language codes created by a compiler, and high-level language codes that can be executed by a computer by using an interpreter. When all or some of a base station or a relay described in the present disclosure is implemented by a computer program, a computer-readable recording medium storing the computer program is also included in the present disclosure. Therefore, the scope of the disclosure is defined not by the detailed description of the disclosure but by the appended claims, and all differences within the scope will be construed as being included in the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for Transmission Control Protocol (TCP) recovery in a transmitter for a wireless communication system, the method comprising:
detecting an event for releasing a Radio Resource Control (RRC) connection with a receiver;
storing a TCP packet for the receiver when the RRC connection is released;
reestablishing the RRC connection with the receiver;
determining whether a session for the stored TCP packet exists; and
transmitting the stored TCP packet to the receiver when determined that the session for the stored TCP packet exists.

2. The method of claim 1, further comprising:
determining whether a TCP packet for the receiver exists in a radio bearer when the event for releasing the RRC connection is detected;
comparing a number of TCP packets for the receiver existing in the radio bearer with a threshold value when determined that the TCP packet for the receiver exists in the radio bearer; and
storing the TCP packet for the receiver when the number of TCP packets is larger than the threshold value.

3. The method of claim 2, further comprising discarding the TCP packet without storing the TCP packet when the number of the TCP packets is less than or equal to the threshold value.

4. The method of claim 1, further comprising:
determining whether a Radio Link Control (RLC) layer operates in an Acknowledged Mode (AM) when the event for releasing the RRC connection is detected; and
storing the TCP packet for the receiver when the RLC layer operates in the AM.

5. The method of claim 4, further comprising discarding the TCP packet for the receiver without storing the TCP packet when the RLC layer does not operate in the AM.

6. The method of claim 1, wherein the storing of the TCP packet for the receiver comprises:
determining session information of the TCP packet and time information representing a RRC connection release time; and
mapping the determined session information and the time information onto the TCP packet and storing the TCP packet.

7. The method of claim 6, wherein the session information of the TCP packet includes at least one of a source IP address, a source port, a destination IP address, a destination port, and a protocol.

8. The method of claim 6, wherein the determining of whether the session for the stored TCP packet exists comprises determining whether a TCP packet having same session information as session information of the stored TCP packet is received.

9. The method of claim 6, further comprising:
determining whether a storage time of the TCP packet exceeds a threshold time based on the RRC connection release time mapped onto the stored TCP packet; and
discarding the stored TCP packet when the storage time of the TCP packet exceeds the threshold time.

10. The method of claim 9, wherein the determining of whether the storage time of the TCP packet exceeds the threshold time comprises:
determining a difference time between the RRC connection release time mapped onto the stored TCP packet and a current time; and
determining that the storage time of the TCP packet exceeds the threshold time when the determined difference time is larger than or equal to the threshold time.

11. An apparatus for a transmitter for Transmission Control Protocol (TCP) recovery in a wireless communication system, the apparatus comprising:
a communication unit configured to transmit and receive signals to and from a receiver; and
a control unit configured to detect an event for releasing a Radio Resource Control (RRC) connection with a receiver, to store a TCP packet for the receiver, to determine whether a session for the stored TCP packet exists when the RRC connection with the receiver is reestablished, and to transmit the stored TCP packet to the receiver when determined that the session for the stored TCP packet exists.

12. The apparatus of claim 11, wherein the control unit determines whether a TCP packet for the receiver exists in a radio bearer when the event for releasing the RRC connection is detected, compares a number of TCP packets for the receiver existing in the radio bearer with a threshold value when the TCP packet for the receiver exists in the radio bearer, and stores the TCP packet for the receiver when the number of the TCP packets is larger than the threshold value.

13. The apparatus of claim 12, wherein the control unit discards the TCP packet without storing the TCP packet when the number of the TCP packets is less than or equal to the threshold value.

14. The apparatus of claim 11, wherein the control unit determines whether a Radio Link Control (RLC) layer operates in an Acknowledged Mode (AM) when the event for releasing the RRC connection is detected and stores a TCP packet for the receiver when the RLC layer operates in the AM.

15. The apparatus of claim 14, wherein the control unit discards the TCP packet for the receiver without storing the TCP packet when the RLC layer does not operate in the AM.

16. The apparatus of claim 11, wherein the control unit determines session information of the TCP packet and time information representing a RRC connection release time and maps the determined session information and the determined time information onto the TCP packet to store the TCP packet.

17. The apparatus of claim 16, wherein the session information of the TCP packet includes at least one of a source IP address, a source port, a destination IP address, a destination port, and a protocol.

18. The apparatus according to claim 16, wherein the control unit determines whether a TCP packet having same session information as session information of the stored TCP packet is received.

19. The apparatus of claim 16, wherein the control unit determines whether a storage time of the TCP packet exceeds a threshold time based on the RRC connection release time mapped onto the stored TCP packet, and discards the stored TCP packet when the storage time of the TCP packet exceeds the threshold time.

20. The apparatus of claim 19, wherein the control unit determines a difference time between the RRC connection release time mapped onto the stored TCP packet and a current time, and determines that the storage time of the TCP packet exceeds the threshold time when the determined difference time is larger than or equal to the threshold time.
